(19) United States
(12) Patent Application Publication
(10) Pub. No.: US 2021/0049733 A1
(43) Pub. Date: Feb. 18, 2021

(54) Dual-Stream Pyramid Registration Network

(71) Applicant: Shenzhen Malong Technologies Co., Ltd., Shenzhen (CN)

(72) Inventors: Miao KANG, Shenzhen (CN); Xiaojun HU, Shenzhen (CN); Weilin HUANG, Shenzhen (CN); Matthew Robert SCOTT, Shenzhen (CN)

(21) Appl. No.: 16/539,085

(22) Filed: Aug. 13, 2019

(51) Int. Cl. G06T 3/00; G06T 3/40; G06T 7/33; G06T 7/187

(52) U.S. Cl. CPC G06T 3/0068; G06T 3/0093; G06T 3/40; G06T 2207/30016; G06T 7/187; G06T 2207/20016; G06T 2207/20221; G06T 7/337

(57) ABSTRACT

Aspects of this disclosure include technologies for object registration based on a dual-stream pyramid registration network, which is configured to compute multi-scale deformation fields from dual feature pyramids. The disclosed technologies further enable the multi-scale deformation fields to be refined in a coarse-to-fine manner, resulting in the capability for handling significant deformations between two objects, such as large displacements in spatial domain or slice space. Further, the disclosed technologies enable various functions based on the registered objects, such as automatic labeling, image comparison and differentiation, and medical image registration and navigation.

### BACKGROUND

Object registration is a process for aligning two-dimensional (2D) or three-dimensional (3D) objects in one coordinate system. Common objects includes two-dimensional photographs or three-dimensional volumes, potentially taken from different sensors, times, depths, or viewpoints. Typically, the moving or source object is spatially transformed to align with the fixed or target object with a stationary coordinate system or reference frame.

In the technical field of computer vision, the transformation models of object registration may be generally classified into two types, linear transformations and nonrigid transformations. Linear transformations refer to rotation, scaling, translation, and other affine transforms, which generally transform the moving image globally without considering local geometric differences. Conversely, nonrigid transformations locally warp a part of the moving object to align with the fixed object. Nonrigid transformations include radial basis functions, physical continuum models, and other models.

For three-dimensional images, traditional nonrigid transformation models often have to compute voxel-level similarity as a complex optimization problem, which can be computationally prohibitive and inefficient. Even more problematically, traditional nonrigid transformations often fail to handle significant deformations between two volumes, such as significant spatial displacements. Therefore, new technical solutions are needed for object registration, especially when the objects have significant deformations.

### SUMMARY OF THE INVENTION

This Summary is provided to introduce some of the concepts that are further described below in the Detailed Description. This Summary is not intended to identify key features or essential features of the claimed subject matter, nor is it intended to be used as an aid in determining the scope of the claimed subject matter.

Aspects of this disclosure include a technical solution for object registration, including for 3D objects with significant deformations. To register the moving object to the fixed object, the disclosed system may initially generate two respective feature pyramids from the two objects. Each feature pyramid may have sequential levels with different features. Further, the disclosed system may estimate sequential deformation fields based on respective level-wise feature maps from corresponding levels of the two feature pyramids.

During this process, the disclosed system may encode information for registering the two objects in a coarse-to-fine manner into the set of sequential deformation fields, e.g., by sequentially warping, based on the sequential deformation fields, level-wise feature maps of at least one of the two feature pyramids. Accordingly, the final deformation field may contain both high-level global information and low-level local information to register the two objects. Resultantly, the moving object may be aligned to the fixed object based on the final deformation field. After the registration, based on the same coordinate system, features of the two objects may be compared, grafted to each other, or even transferred to a new object.

In various aspects, systems, methods, and computer-readable storage devices are provided to improve a computing device's ability to register objects and generate new image features based on object registration. To achieve the additional technical effect of handling significant deformations between a pair of objects, a dual-stream pyramid registration network is disclosed to directly estimate deformation fields from level-wise feature maps of respective feature pyramids derived from the pair of objects. Further, as the final deformation field contains the multi-level context information of the pair of objects, the disclosed technologies enable an end-to-end object registration process with the final deformation field only. Even further, the disclosed technologies can enable a computing device to register the pair of objects at a specific selected level based on a selected deformation field from the set of sequential deformation fields.

### BRIEF DESCRIPTION OF THE DRAWINGS

The technology described herein is illustrated by way of example and not limited in the accompanying figures in which like reference numerals indicate similar elements and in which:

FIG. 1 is a block diagram illustrating an exemplary system for registering objects, in accordance with at least one aspect of the technology described herein;

FIG. 2 is a schematic representation illustrating some applications of object registration, in accordance with at least one aspect of the technology described herein;

FIG. 3 is a schematic representation illustrating an exemplary network for generating deformation fields, in accordance with at least one aspect of the technology described herein;

FIG. 4 is a flow diagram illustrating an exemplary process of registering objects, in accordance with at least one aspect of the technology described herein;

FIG. 5 is a flow diagram illustrating another exemplary process of registering objects, in accordance with at least one aspect of the technology described herein;

FIG. 6 is a block diagram of an exemplary computing environment suitable for use in implementing various aspects of the technology described herein.

### DETAILED DESCRIPTION

The various technologies described herein are set forth with sufficient specificity to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies.

Deformable registration allows a non-uniform mapping between objects, e.g., by deforming one image to match the other. Like in other technical fields, the technology of deformable registration has many potential applications in the medical field. By way of example, the anatomical correspondence, learned from medical image registration, e.g., between a pair of images taken from different imaging modalities, may be used for assisting image diagnostics, disease monitoring, surgical navigation, etc.

However, traditional deformable registration methods can only correct small discrepancies, e.g., deformations of small spatial extent. Further, traditional deformable registration methods for 3D volumes often cast the process into a complex optimization problem that requires intensive computation by computing voxel-level similarity densely, which can be computationally prohibitive and inefficient.

Even further, traditional deformable registration methods often require strong supervision information, such as ground-truth deformation fields or landmarks. However, obtaining a large-scale dataset with robust annotations is extremely expensive, which inevitably limits the applications of the supervised approaches.

Unsupervised learning-based registration methods have been developed, e.g., by learning a registration function that maximizes the similarity between a moving image and a fixed image. However, previous unsupervised learning-based registration methods usually only have limited efficacy on challenging situations, e.g., where two medical images or volumes have significant spatial displacements or large slice spaces. In other words, the existing deformable registration methods often fail to handle significant deformations, such as significant spatial displacements. Therefore, new technical solutions are needed for deformable registration, especially with issues of significant deformations of three-dimensional volumes.

In this disclosure, technical solutions are provided for registering objects, including three-dimensional objects with significant deformations. In some embodiments, a dual-stream pyramid registration network is used for unsupervised three-dimensional image registration. Unlike prior neural network based registration approaches, which typically utilize a single-stream encoder-decoder network, the disclosed technical solution includes a dual-stream architecture to compute multi-scale deformation fields. In some embodiments, convolutional neutral networks (CNNs) are used in the dual-stream architecture to generate dual convolutional feature pyramids corresponding to a pair of input volumes. In turn, the dual convolutional feature pyramids, as deep multi-scale representations of the pair of input volumes, could be used to estimate multi-scale deformation fields. The multi-scale deformation fields could be refined in a coarse-to-fine manner via sequential warping. Resultantly, the final deformation field is equipped with the capability for handling significant deformations between two volumes, such as large displacements in spatial domain or slice space.

In this disclosure, “registering” objects or images refers to aligning common or similar features of 2D or 3D objects into one coordinate system. In various embodiments, one object is considered as fixed while the other object is considered as moving. Registering the moving object to the fixed object involves estimating a deformation field (e.g., a vector field) that maps from coordinates of the moving object to those of the fixed object. The moving object may be warped, based on the deformation field, in a deformable registration process to register to the fixed object. Further, as used hereinafter, object registration and image registration are used herein interchangeably for applications in the field of computer vision.

At a high level, to register the moving object to the fixed object, the disclosed system may initially generate respective feature pyramids from the two objects. Each feature pyramid may have sequential levels of features or feature maps. Further, the disclosed system may estimate sequential deformation fields based on respective level-wise features from corresponding levels of the two feature pyramids. During this process, the disclosed system may encode information for registering the two objects in a coarse-to-fine manner into the sequential deformation fields, e.g., by sequentially warping, based on the sequential deformation fields, level-wise feature maps of at least one of the two feature pyramids. Accordingly, the final deformation field may contain both high-level global information and low-level local information to register the two objects. Resultantly, the moving object may be aligned to the fixed object based on the final deformation field.

After the registration, based on the same coordinate system, features of the two objects may be compared, grafted to each other, or even transferred to a new object. In one embodiment, the differences between the two objects are marked out, so that the reviewers can easily make inferences from the marked differences. In one embodiment, a feature from the moving object is grafted to the fixed object, or vice versa, based on the same coordinate system. In one embodiment, a new object is created based on selected features from the fixed object, the moving object, or both. In other embodiments, object registration, based on the disclosed dual-stream pyramid registration network, can enable many other practical applications.

Advantageously, the disclosed technologies possess strong feature learning capabilities, e.g., by deriving the dual feature pyramids; fast training and inference capabilities, e.g., by warping level-wise feature maps instead of the objects for refining the deformation fields; robust technical effects, e.g., registering objects with significant spatial displacements; and superior performance, e.g., when compared to many other state-of-the-art approaches.

In terms of performance, the disclosed technologies outperform many existing technologies. In one experiment, when the disclosed system is evaluated on two standard databases (LPBA40 and Mindboggle101) for brain magnetic resonance imaging (MM) registration, the disclosed system outperforms other state-of-the-art approaches by a large margin in terms of average Dice score. Specifically, on an LPBA40 database, the disclosed system obtains an average Dice score of 0.778 and outperforms existing models by a large margin, e.g., over VoxelMorph (0.683), which is an existing model. Further, the disclosed system achieves the best performance on six evaluated regions. On a Mindboggle101 database, the disclosed system consistently outperforms the other approaches, e.g., with a high average Dice score of 0.631, comparing to 0.511 of VoxelMorph.

In these experiments, the registration results also visually reveal that the disclosed technologies can align the images more accurately than other state-of-the-art approaches (e.g., VoxelMorph), especially on the regions containing large spatial displacements. Further, the disclosed technologies are also evaluated on large slice displacements, which may cause large spatial displacement. Experiments were conducted on LPBA40, by reducing the slices of the moving volumes from 160×192×160 to 160×24×160. During testing, the estimated final deformation field is applied to the labels of the moving volume using zero-order interpolation. With a significant reduction of slices from 192 to 24, the disclosed system can still obtain a high average Dice score of 0.711, which even outperforms other state-of-the-art approaches (e.g., VoxelMorph) using the original non-reduced volumes containing the original 192 slices. These experiments demonstrate the robustness of the disclosed technology against large spatial displacements, including what are caused by large slice displacements.

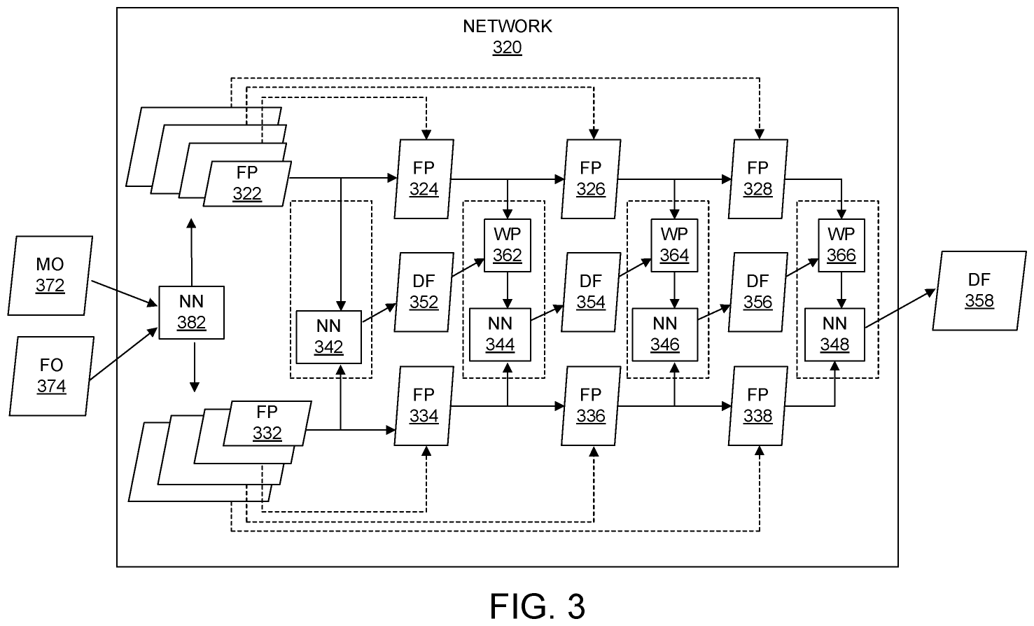

Further experiments have been conducted to visualize registration results with respective deformation fields generated from the disclosed system, e.g., network 320 in FIG. 3. Those experiments confirm that the deformation field generated from a lower-resolution layer contains coarse high-level context information, which is able to warp a volume at a relatively larger scale. Conversely, the deformation field estimated from a higher-resolution layer can capture more fine detailed features, but warp the volume at a relatively smaller scale. Further, when the deformation fields are refined, the corresponding warped images from the moving image are also refined gradually toward the fixed image by aggregating more detailed structural information. The final deformation field leads to a satisfactory registration in some embodiments.

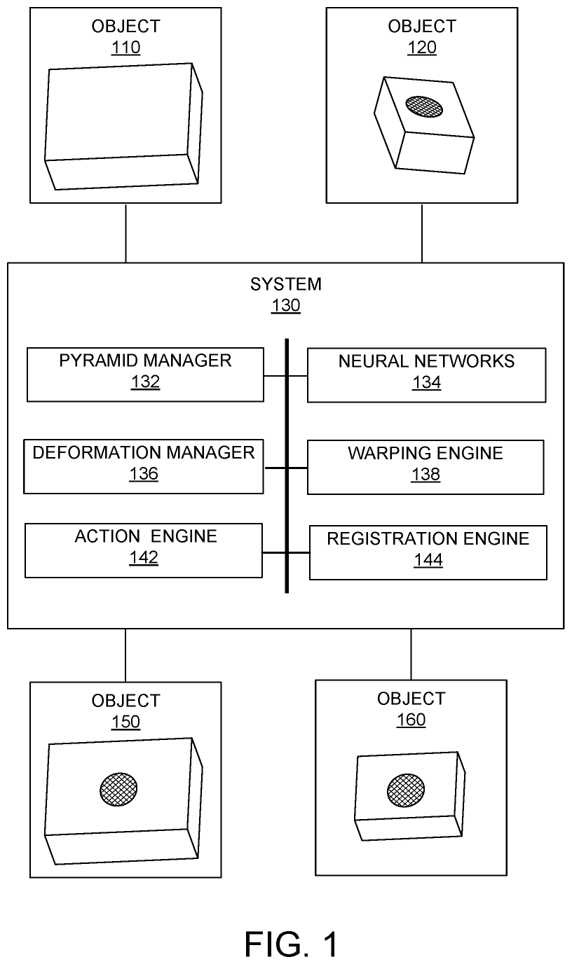

Having briefly described an overview of aspects of the technology described herein, an exemplary operating environment in which aspects of the technology described herein may be implemented is described below. Referring to the figures in general and initially to FIG. 1 in particular, an exemplary system for implementing object registration is shown. This system is merely one example of a suitable system and is not intended to suggest any limitation as to the scope of use or functionality of aspects of the technology described herein. Neither should this system be interpreted as having any dependency or requirement relating to any one component nor any combination of components illustrated.

Turning now to FIG. 1, a block diagram is provided showing an exemplary system 130 in which some aspects of the present disclosure may be employed. It should be understood that this and other arrangements described herein are set forth only as examples. Other arrangements and elements (e.g., machines, interfaces, functions, orders, and grouping of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by an entity may be carried out by hardware, firmware, and/or software. For instance, some functions may be carried out by a processor executing instructions stored in memory.

At a high level, system 130 includes a dual-stream pyramid registration network (e.g., network 320 as shown in FIG. 3) for unsupervised object registration. Functionally, system 130 may include pyramid manager 132, neural networks 134, deformation manager 136, warping engine 138, action engine 142, and registration engine 144, in addition to other components not shown in FIG. 1. Accordingly, system 130 can perform not only object registration, but various other functions after registering objects, such as image comparison, image editing, image generation, image diagnostics, disease monitoring, surgical navigation, etc.

In some embodiments, pyramid manager 132 may use neural networks 134 to generate respective feature pyramids from object 110 and object 120. Neural networks 134 may include a feature pyramid network (FPN), which is configured to extract features from an object, and generate multi-resolution or multi-scale feature maps accordingly. In one embodiment, different convolution modules (e.g., with different strides) are used to generate the multi-scale feature maps for a feature pyramid. Each feature pyramid may have sequential levels. Structurally, the sequential levels may have different spatial dimensions or resolutions. Semantically, the sequential levels may have different features corresponding to the different convolution modules. For example, lower resolution levels may contain convolutional features reflecting coarse-scale global information of the object, while higher resolution levels may contain convolutional features reflecting fine-scale local information of the object.

In some embodiments, deformation manager 136 may use neural networks 134 and warping engine 138 to estimate a sequential layerwise deformation fields based on respective level-wise feature maps from corresponding levels of the feature pyramids. Each deformation field is a mapping function to align object 120 to object 110 to a certain extent.

Deformation manager 136 may use neural networks 134 to generate the sequential deformation fields, e.g., based on respective levels (level-wise features or level-wise feature maps) of the feature pyramids. Further, deformation manager 136 may refine the sequential layerwise deformation fields in a coarse-to-fine manner, e.g., by using warping engine 138 to sequentially warp, based on respective deformation fields, level-wise feature maps of the feature pyramid of the moving object.

During this process, deformation manager 136 may encode information for object registration in a coarse-to-fine manner. For example, the first deformation field may contain the high-level global information (e.g., structural information), which enables registration engine 144 to handle large deformations. The final deformation field may contain both high-level global information and low-level local information (e.g., fine details) to register the two objects. In the context of brain imaging, deformation manager 136 will generate the final deformation field to preserve both high-level information of anatomical structure of the brain and low-level information of local details of different regions of the brain.

Resultantly, registration engine 144 may use warping engine 138 to warp, based on a selected deformation field, the moving object, e.g., object 120, to align with the fixed object, e.g., object 110. In one embodiment, registration engine 144 generates a new object 160, which is a warped version of object 120, after applying a deformation field. Depend on various applications, if the final deformation field is selected, the deformable registration process will be able to resolve large deformations as well as preserve local details. If an intermediate deformation field is selected, the deformable registration process will still be able to resolve large deformations, but may preserve less local details.

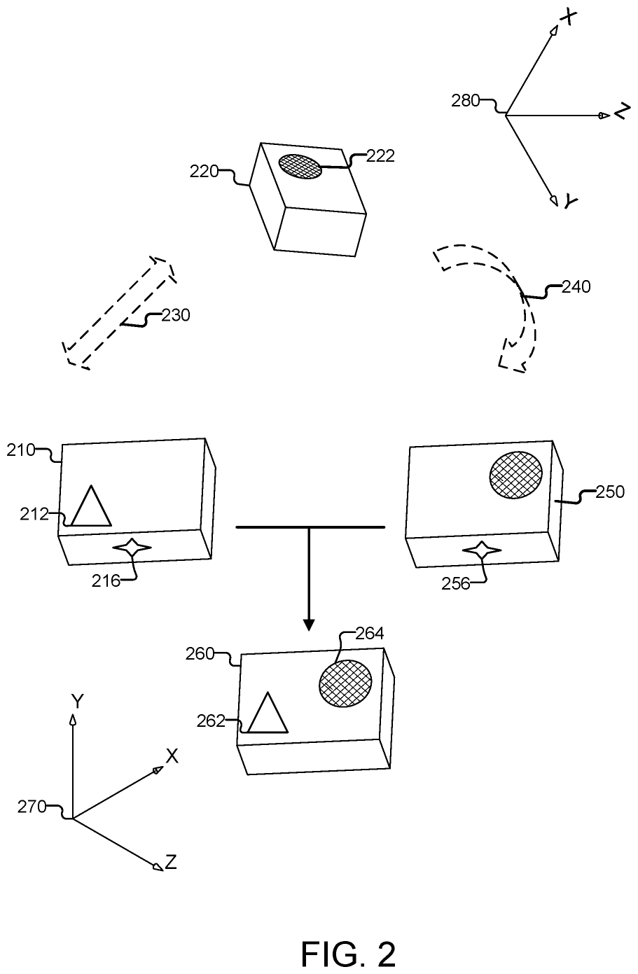

In various embodiments, action engine 142 is to perform practical actions based on object registration. In one embodiment, action engine 142 is to generate a new object 150 based on respective features from object 110 and object 160 after registering object 120 to object 110. In other embodiments, action engine 142 may be configured to perform actions in augmented reality, virtual reality, mixed reality, video processing, medical imaging, etc. Some of these actions will be further discussed in connection with FIG. 2.

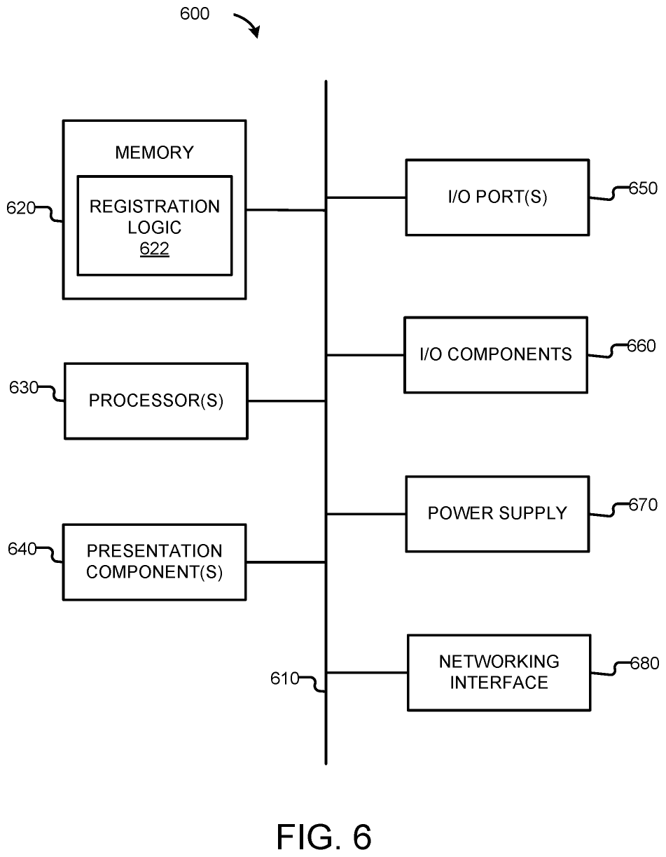

It should be understood that this operating environment shown in FIG. 1 is an example. Each of the system components shown in FIG. 1 may be implemented, individually or in any combinations, on any type of computing devices, such as computing devices 600 described in FIG. 6, for example. Further, each of the system components shown in FIG. 1 may communicate with each other, or with other systems, via a network, which may include, without limitation, a local area network (LAN) or a wide area network (WAN). In exemplary implementations, WANs include the Internet or a cellular network, amongst any of a variety of possible public or private networks. For example, neural networks 134 may be located in a computing cloud, and operatively connected to other components in system 130 via a network.

Referring now to FIG. 2, a schematic representation is provided to illustrate some applications of object registration. The disclosed technology can determine multi-scale deformation fields from the decoding feature pyramids, e.g., by sequentially refining these deformation fields based on the level-wise feature maps from the feature pyramids. This results in a high-performance model that can better handle large deformations. With these technical improvements, the disclosed technology can be applied to many applications of object registration and significantly outperform traditional technologies.

One practical application, enabled by the disclosed technology, is object registration. Target object 210 and source object 220 may be taken or constructed by the same imaging technique or different imaging technologies, such as photography (e.g., still images, videos), medical optical imaging (e.g., optical microscopy, spectroscopy, endoscopy, scanning laser ophthalmoscopy, and optical coherence tomography), sonography (e.g., ultrasound imaging), radiography (e.g., X-rays, fluoroscopy, angiography, contrast radiography, computed tomography (CT), computed tomography angiography (CTA), MM, etc.), stereo photography, 3D reconstruction, etc.

In some embodiments, target object 210 with visual feature 212 is a fixed object, while source object 220 with visual feature 222 is a moving object. In matching process 230, source object 220 and target object 210 are matched together, e.g., when target object 210 and source object 220 are two different images for the same subject.

The disclosed technology derives feature pyramids from source object 220 and target object 210, and further predicts multi-scale deformation fields from the decoding feature pyramids. In registration process 240, source object 220 is warped into warped object 250 based on at least one of the multi-scale deformation fields, e.g., the final deformation field.

In some embodiments, warped object 250 is compared to target object 210 for feature differentiation based on the same coordinate system. By way of example, after being placed in the same coordinate system, warped object and target object 210 can be easily compared visually. A reviewer may notice that visual feature 212 is unique to target object 210 because the warped image does not have the same feature at the same location. Conversely, visual feature 222 is unique to source object 220 for the same reason.

In some embodiments, visual features from one object may be grafted to another object based on the same coordinate system. By way of example, object 260 illustrates the result after grafting visual feature 212 to warped object 250. This type of application could be extremely useful. For instance, target object 210 may be a pre-operative image, and source object 220 may be an intra-operative image for the same subject. The intra-operative image may not show all anatomical features, but it would be a mistake to operate on the location of visual feature 262, for example, a nerve. However, with the disclosed technology, now surgeons can carefully work around visual feature 262 without dire damages.

Manually labeling features used to be an expensive but necessary operation for machine learning in many fields. Enabled by the disclosed technology, unlabeled visual features or locations in one object may be labeled based on known labels for corresponding visual features or locations in another object. By way of example, visual feature 256 is hidden from the perspective view of source object 220 based on the coordinate system 280 as illustrated. After registering source object 220 to target object 210, warped object 250 and target object 210 are put into the same coordinate system 270. Resultantly, not only has visual feature 256 become visible, but visual feature 216 and visual feature 256 may be recognized as the same or similar features, e.g., by feature comparison techniques. Accordingly, visual feature 216 may be labeled based on the label of visual feature 216. In another embodiment, visual feature 216 and visual feature 256 both refer to their respective locations. By the same token, one unlabeled location may be labeled based on the label of another location. In other words, the disclosed technology enables marking or labeling a feature or location on one object based on the corresponding feature or location on another object.

In some embodiments, a new object 260 is generated based on selected features from target object 210 and source object 220. Visual feature 212 is placed on object 260 based on its location on target object 210, or the coordinates of visual feature 212 in respect to the orientation of target object 210. Similarly, visual feature 222 is placed on object 260 based on its location on source object 220, or the coordinates of visual feature 222 in respect to the orientation of source object 220. However, the absolute orientations of target object 210 or source object 220 are less helpful because these objects are not aligned in the same coordinate system. Without the disclosed technology, it is difficulty to model the spatial relationship between features from different objects, especially for 3D volumes with significant spatial deformations. With the disclosed technology, after registering source object 220 to target object 210, the spatial relationship between visual feature 212 and visual feature 222 is determined based on the same coordinate system. Accordingly, respective locations or coordinates of visual feature 262 and visual feature 264 may be properly determined for object 260.

In one embodiment, the newly generated object 260 is configured to show only different visual features of source object 220 and target object 210. In this case, visual feature 216 and visual feature 256 are determined to be common in terms of their locations in the same coordinate system as well as their other feature characteristics, such as shape, color, density, etc. Accordingly, object 260 does not show this common visual feature, but only show distinguishable visual features, such as visual feature 262 and visual feature 264.

These aforementioned applications may be implemented in various medical fields, e.g., image-guided cardiac interventions, image-guided surgery, robotic surgery, medical image reconstruction, perspective transformations, medical image registration, etc. As discussed previously, one object may be a pre-operative image, while another object may be an intra-operative image. Alternatively, the two images may be formed by different modalities of imaging techniques. Image registration, enabled by the disclosed technology, may then be used for image-guided surgery or robotic surgery.

These aforementioned applications may also be implemented in various other fields, e.g., augmented reality, virtual reality, or mixed reality. For example, target object 210 may be a part of the present view, while source object 220 may be a part of the historical view. Object 260 may be a part of the augmented view, e.g., by adding visual feature 264 from the historical view of the present view.

Referring now to FIG. 3, a schematic representation is provided illustrating network 320 for generating deformation fields. Network 320 is an example of a dual-stream pyramid registration network.

In some embodiments, for 3D object registration, network 320 is to estimate a deformation field Φ which can be used to warp a moving volume M⊂R³ to a fixed volume F⊂R³, so that the warped volume W=M(Φ)⊂R³ is aligned to the fixed volume F. M(Φ) is used herein to denote the application of a deformation field Φ to the moving volume with a warping operation. The warping operation may be achieved via a spatial transformer network (STN), e.g., M(Φ)=fₛₜₙ(M, Φ).

$$\hat{Φ} = arg {min}_{Φ} L ( F , M , Φ ) , L ( F , M , Φ ) = {L}_{sim} ( F , M ( Φ ) ) + λ {L}_{smooth} ( Φ ) \qquad Eq . 1$$

Object registration may be formulated as an optimization problem as represented by Eq. 1, where Lₛᵢₘ is a function that measures image similarity between M(Φ) and F, and Lₛₘₒₒₜₕ is a regularization constraint on P which enforces spatial smoothness. Both Lₛᵢₘ and Lₛₘₒₒₜₕ can be defined in various forms. Further, a negative local cross correlation is adopted as loss function, which is coupled with a smooth regularization in one embodiment.

Different from many conventional technologies, network 320 implements a dual-steam model to generate dual feature pyramids as the basis to estimate the deformation field P. In comparison, conventional technologies, such as the VoxelMorph model or U-Net, use a single-stream encoder-decoder architecture. For example, the pair of objects are stacked as a single input in the VoxelMorph model.

Here, MO 372 and FO 374, representing their respective objects, are two data streams to NN 382, which is a convolutional neutral network in some embodiments. NN 382 is configured to generate dual feature pyramids with sequential levels. For example, the feature pyramid for MO 372 may include multiple levels, such as FP 322, FP 324, FP 326, and FP 328. Similarly, the feature pyramid for FO 374 may include multiple levels, such as FP 332, FP 334, FP 336, and FP 338. Although FIG. 3 illustrates only four levels for a feature pyramid, as would be understood by a person skilled in the art, a feature pyramid in another embodiment may have more or less levels.

In one embodiment, NN 382 contains an encoder and a decoder. In the encoder, each of the four down-sampling convolutional blocks has a 3D down-sampling convolutional layer with a stride of 2. Thus the encoder reduces the spatial resolution of input volumes by a factor of 16 in total in this embodiment. Except for the first block, the down-sampling convolutional layer is followed by two ResBlocks, each of which contains two convolutional layers with residual connection similar to ResNet. Further, BN operations and ReLU operations may be applied.

In the decoder, skip connections are applied on the corresponding convolutional maps. Features are fused using a Refine Unit, where the convolutional maps with a lower resolution are up-sampled and added into the higher-resolution ones, e.g., using a 1×1×1 convolutional layer. In this way, respective feature pyramids with multi-resolution convolutional feature maps are computed from MO 372 (e.g., the moving volume) and FO 374 (e.g., the fixed volume).

Different levels of a feature pyramid represent different features, alternatively, features in different levels. Different features may be generated based on different convolution modules. Further, different levels may have different resolutions in some embodiments. For example, convolutional features reflecting coarse-scale global information of the object may be encoded in a relatively low resolution level. Conversely, convolutional features reflecting fine-scale local information of the object may be encoded in a relatively high resolution level. In this embodiment, FP 324 has a higher resolution compared to FP 322. Likewise, FP 326 has a higher resolution compared to FP 324, and FP 328 has a higher resolution compared to FP 326. In various embodiments, different levels from the dual feature pyramids may be paired, e.g., based on the order of the level in the sequence, its convolutional features, or its resolutions. Feature maps from the same level of the dual feature pyramids may be used to generate a layerwise deformation field.

As shown in FIG. 3, network 320 is configured to estimate multiple deformation fields with different resolutions. Specifically, network 320 is to compute layerwise deformation fields from the respective convolutional feature maps at each level of the dual feature pyramids. Each deformation field is computed by using a sequence of operations with feature warping, stacking, and convolution, except for the first deformation field which is computed without feature warping. This results in multiple deformation fields with increasing resolutions, starting from the lowest resolution layer to the highest resolution layer. In this embodiment, each feature pyramid includes four levels, and thus four deformation fields are generated, including DF 352, DF 354, DF 356, and DF 358.

In more details, the first deformation field DF 352 is computed based on features or feature maps at the level of FP 322 and FP 332. In one embodiment, a 3D convolution with size of 3×3×3 may be applied to the stacked convolutional features from FP 322 and FP 332, to estimate DF 352. In one embodiment, DF 352 is a 3D volume in the same scale of the convolutional feature maps at the corresponding level, such as FP 322 and FP 332. DF 352 has encoded coarse context information, such as high-level global information (e.g., the anatomical structure of brain images) of MO 372 or FO 374, which is then used for generating the next deformation field, e.g., by a feature warping operation.

In the feature warping operation, the present deformation field (e.g., DF 352) is up-sampled, e.g., by using bilinear interpolation with a factor of 2, denoted as u(Φ₁). Then, the up-sampled deformation field is used to warp the convolutional features of the next level (e.g., FP 324) from the moving object (e.g., MO 372), e.g., by using a grid sample operation. Then, the warped convolutional features are stacked again with the convolutional features of the corresponding level (e.g., FP 334) generated from the fixed volume, followed by a convolution operation to generate a new deformation field (e.g., DF 354).

Φᵢ=Cᵢ^{3×3×}(Pᵢ^{M}*u(Φᵢ₋₁), Pᵢ^{F}) Eq. 2

This process is repeated level-wise and may be formulated as Eq. 2, where I=1, 2, . . . , N. N is set to 4 in this embodiment, which refers to the four levels in each feature pyramid. Cᵢ^{3×3×3} denotes a 3D convolution at the i-th decoding layer, and the “* ” operator refers to a warping operation. Pᵢ^{M} and Pᵢ^{F} are the convolutional feature pyramids computed from the moving volume and the fixed volume at the i-th layer. Resultantly, four sequential deformation fields are generated by network 320, including DF 352, DF 354, DF 356, and DF 358. Specifically, DF 352 is generated based on NN 342, FP 322, and FP 332. DF 354 is generated based on NN 344, WP 362, FP 324, and FP 334. DF 356 is generated based on NN 346, WP 364, FP 326, and FP 336. Finally, DF 358 is generated based on NN 348, WP 366, FP 328, and FP 338.

In this network, the estimated deformation fields are warped sequentially and recurrently with up-sampling, to generate the final deformation field, which encodes meaningful multi-level context and deformation information. Network 320 propagates strong context information over hierarchical layers. The sequential deformation fields are refined gradually in a coarse-to-fine manner, which leads to the final deformation field with both high-level global information and low-level local information. The high-level global information enables the disclosed technology to work on large deformations, while the low-level local information allows the disclosed technology to preserve detailed local structure. In this embodiment, it may be said that the fourth deformation field (i.e., DF 358) is configured to contain information of the first deformation field (i.e., DF 352), the second deformation field (i.e., DF 354), and the third deformation field (i.e., DF 356).

This exemplary network illustrates a dual-stream design, which computes feature pyramids from two input data streams separately, and then predicts the deformable fields from the learned, stronger and more discriminative convolutional features. Accordingly, network 320 differs from those existing single-stream networks, which may stack input data streams or jointly estimate a deformation field using the same convolutional filters. Furthermore, network 320 generates two paired feature pyramids where layerwise deformation fields can be computed at multiple scales. In a pyramid registration model, each of the deformation fields may be used for object registration, although different deformation fields likely will lead to different technical effects. For example, a deformation field generated from a lower-resolution layer contains coarse high-level information, such deformation field is able to warp a volume at a relatively larger scale. Conversely, the deformation field estimated from a higher-resolution layer generally captures more detailed local information, but such deformation field may warp the volume at a relatively smaller scale.

In general, each deformation field generated by network 320 is able to handle large-scale deformations. Comparatively, many existing models (e.g., VoxelMorph) only compute a single deformation field in the decoding process, which is one of the reasons for limiting their capabilities for handling large-scale deformations.

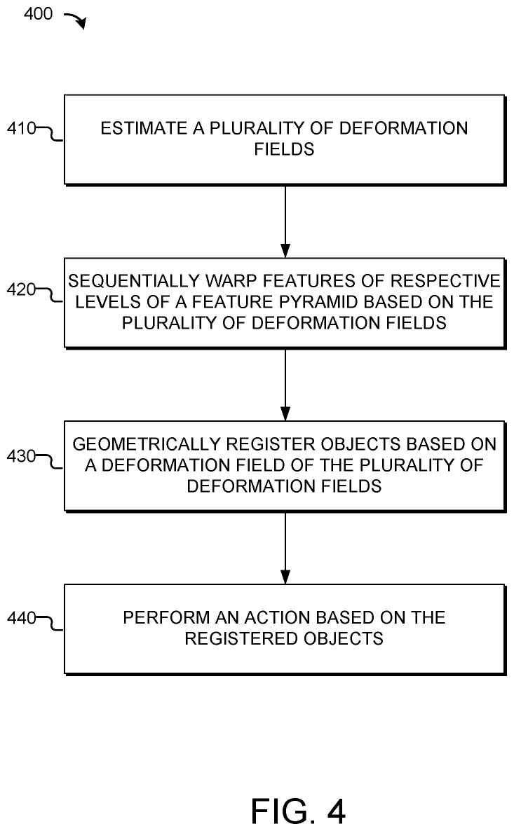

Referring now to FIG. 4, a flow diagram is provided that illustrates an exemplary process of registering objects. Each block of process 400, and other processes described herein, comprises a computing process that may be performed using any combination of hardware, firmware, or software. For instances, various functions may be carried out by a processor executing instructions stored in memory. The process may also be embodied as computer-usable instructions stored on computer storage media or devices. The process may be provided by an application, a service, or in combination thereof.

At block 410, a plurality of deformation fields may be estimated, e.g., by deformation manager 136 of FIG. 1 or based on network 320 of FIG. 3. In various embodiments, the plurality of deformation fields may be estimated based on respective level-wise convolutional feature maps from corresponding levels of two feature pyramids associated with the input objects. Further, the plurality of deformation fields may be refined to encode information of the input objects in a coarse-to-fine manner from high-level information to low-level information.

At block 420, features of respective levels of a feature pyramid may be sequentially warped based on the plurality of deformation fields, e.g., via warping engine 138 in FIG. 1 or network 320 in FIG. 3. In various embodiments, the sequential warping operations are operated on the sequential levels of the moving object based on the sequential deformation fields. Accordingly, a sequential layerwise deformation field may be generated to encode multi-level context information from the dual feature pyramids.

At block 430, objects may be geometrically registered based on a deformation field of the plurality of deformation fields, e.g., via the registration engine 144 in FIG. 1. In some embodiments, the final deformation field is used for object registration as the final deformation field contains both global and local information of the moving object and the fixed object. In some embodiments, geometrically registering two objects includes the process of aligning their respective coordinate systems, such as coordinate system 270 and coordinate system 280 of FIG. 2. In some embodiments, geometrically registering two objects includes warping high-level structure or local details of the moving object.

At block 440, an action may be performed based on the registered objects, e.g., via action engine 142 in FIG. 1. In various embodiments, such actions may include comparing features of the registered objects, grafting features from one object to another, or generating a new object based on features from the registered objects. In various embodiments, such actions may include conducting image-guided surgeries or robotic surgeries. In various embodiments, such actions may include generating an object in augmented reality, virtual reality, or mixed reality.

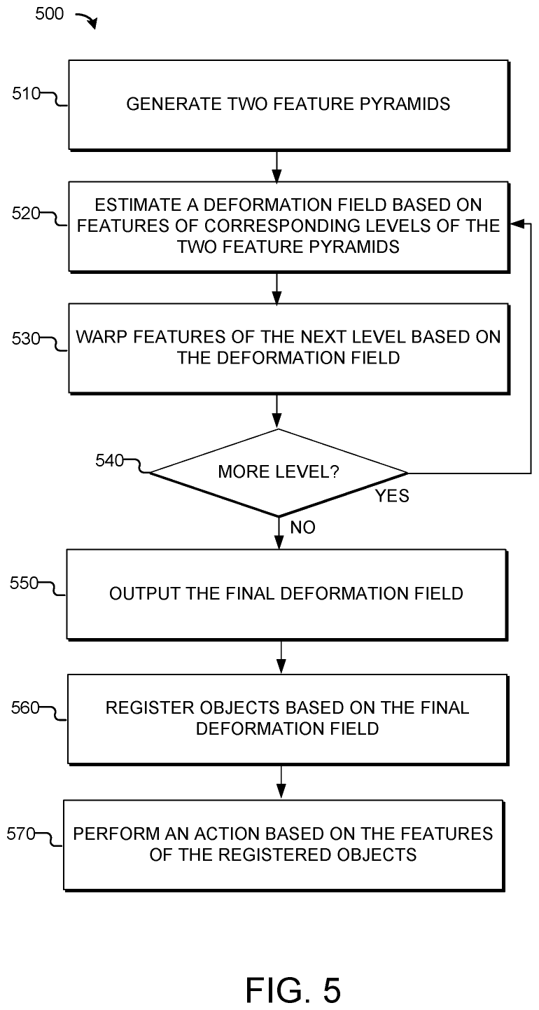

FIG. 5 is a flow diagram illustrating another exemplary process of registering objects. Each block of process 500, and other processes described herein, comprises a computing process that may be performed using any combination of hardware, firmware, or software. For instance, various functions may be carried out by a processor executing instructions stored in memory. The processes may also be embodied as computer-usable instructions stored on computer storage media or devices. The process may be provided by an application, a service, or in combination thereof.

At block 510, two feature pyramids are generated, e.g., via pyramid manager 132 and neural networks 134 in FIG. 1, or NN 382 in FIG. 3. In various embodiments, the two feature pyramids are generated via a dual-stream model from two objects, e.g., as illustrated by network 320 in FIG. 3. Further, each of the two feature pyramids may have a sequential levels of convolutional feature maps. Even further, the sequential levels of feature maps may have sequentially increasing resolutions.

At block 520, a deformation field may be estimated based on features of corresponding levels of the two feature pyramids, e.g., via deformation manager 136 and neural networks 134 in FIG. 1. In various embodiments, a deformation field encodes information from the features or feature maps of corresponding levels of the two feature pyramids, but may inherit information from the previous deformation field, except for the first deformation field. In this way, sequential deformation fields may be refined to encode information of the two objects from high-level information to low-level information.

At block 530, features or feature maps of the next level may be warped based on the deformation field, e.g., via warping engine 138 in FIG. 1. In various embodiments, features of the next level may include one or more convolutional feature maps. In various embodiments, features of the next level may include 3D features. In various embodiments, the deformation field may be up-sampled to match the resolution of the next level.

At block 540, a decision may be made regarding whether there are more levels in the feature pyramid. If there is another unprocessed level, the process returns to block 520. Otherwise, the process moves forward to block 550.

At block 550, the final deformation field is being outputted, e.g., to registration engine 144 in FIG. 1. In various embodiments, the final deformation field contains both high-level global information and low-level local information.

At block 560, the moving object may be registered to the fixed object based on the final deformation field, e.g., via registration engine 144 in FIG. 1. In this way, the two objects may be registered even with large deformations. Meanwhile, the local details in both objects may be preserved. In one embodiment, the two objects are two three-dimensional volumes with different spatial scales, and the two three-dimensional volumes with different spatial scales may be geometrically aligned based on the final deformation field.

At block 570, an action is performed based on the features of the registered objects, e.g., via action engine 142 in FIG. 1. In one embodiment, the two objects are two brain images, and the action includes combining the two aligned brain images to generate a new brain image for diagnosis or treatment.

Accordingly, we have described various aspects of the technology for flow-based image generation. It is understood that various features, sub-combinations, and modifications of the embodiments described herein are of utility and may be employed in other embodiments without references to other features or sub-combinations. Moreover, the order and sequences of steps shown in the above example processes are not meant to limit the scope of the present disclosure in any way, and in fact, the steps may occur in a variety of different sequences within embodiments hereof. Such variations and combinations thereof are also contemplated to be within the scope of embodiments of this disclosure.

Referring to the drawing in general, and initially to FIG. 6 in particular, an exemplary operating environment for implementing aspects of the technology described herein is shown and designated generally as computing device 600. Computing device 600 is but one example of a suitable computing environment and is not intended to suggest any limitation as to the scope of use of the technology described herein. Neither should the computing device 600 be interpreted as having any dependency or requirement relating to any one or combination of components illustrated.

The technology described herein may be described in the general context of computer code or machine-useable instructions, including computer-executable instructions such as program components, being executed by a computer or other machine. Generally, program components, including routines, programs, objects, components, data structures, and the like, refer to code that performs particular tasks or implements particular abstract data types. The technology described herein may be practiced in a variety of system configurations, including general-purpose computers, and smart phone. Aspects of the technology described herein may also be practiced in distributed computing environments where tasks are performed by remote-processing devices that are connected through a communication network.

With continued reference to FIG. 6, computing device 600 includes a bus 610 that directly or indirectly couples the following devices: memory 620, processors 630, presentation components 640, input/output (I/O) ports 650, I/O components 660, and an illustrative power supply 670. Bus 610 may include an address bus, data bus, or a combination thereof. Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O components. Also, processors have memory. The inventors hereof recognize that such is the nature of the art and reiterate that the diagram of FIG. 6 is merely illustrative of an exemplary computing device that can be used in connection with different aspects of the technology described herein. Distinction is not made between such categories as “workstation,” “server,” “laptop,” “handled device,” etc., as all are contemplated within the scope of FIG. 6 and refers to “computer” or “computer device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tapes, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media.

Memory 620 include computer storage media in the form of volatile and/or nonvolatile memory. The memory 620 may removable, non-removable, or a combination thereof. Exemplary memory includes solid-state memory, hard drives, optical-disc drives, etc. Computing device 600 includes processors 630 that read data from various entities such as bus 610, memory 620, or I/O components 660. Presentation component(s) 640 present data indications to a user or other device. Exemplary presentation components 640 include a display device, speaker, printing component, vibrating component, etc. I/O ports 650 allow computing device 600 to be logically coupled to other devices, including I/O components 660, some of which may be built in.

In various embodiments, memory 620 includes, in particular, temporal and persistent copies of registration logic 622. Registration logic 622 includes instructions that, when executed by processor 630, result in computing device 600 performing functions, such as, but not limited to, process 400 and process 500. In various embodiments, registration logic 622 includes instruction that, when executed by processors 630, result in computing device 600 performing various functions associated with, but not limited to pyramid manager 132, neural networks 134, deformation manager 136, warping engine 138, action engine 142, and registration engine 144 in connection with FIG.1.

In some embodiments, processors 630 may be packed together with registration logic 622. In some embodiments, processors 630 may be packaged together with registration logic 622 to form a System in Package (SiP). In some embodiments, processors 630 cam be integrated on the same die with registration logic 622. In some embodiments, processors 630 can be integrated on the same die with registration logic 622 to form a System on Chip (SoC).

Illustrative I/O components include a microphone, joystick, game pad, satellite dish, scanner, printer, display device, wireless device, a controller (such as stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processors 630 may be direct or via a coupling utilizing a serial port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

Computing device 600 may include networking interface 680. The networking interface 680 includes a network interface controller (NIC) that transmits and receives data. The networking interface 680 may use wired technologies (e.g., coaxial cable, twisted pair, optical fiber, etc.) or wireless technologies (e.g., terrestrial microwave, communications satellites, cellular, radio and spread spectrum technologies, etc.). Particularly, the networking interface 680 may include a wireless terminal adapted to receive communications and media over various wireless networks. Computing device 600 may communicate with other devices via the networking interface 680 using radio communication technologies. The radio communications may be a short-range connection, a long-range connection, or a combination of both a short-range and a long-range wireless telecommunications connection. A short-range connection may include a Wi-Fi® connection to a device (e.g., mobile hotspot) that provides access to a wireless communications network, such as a wireless local area network (WLAN) connection using the 802.11 protocol. A Bluetooth connection to another computing device is a second example of a short-range connection. A long-range connection may include a connection using various wireless networks, including 1G, 2G, 3G, 4G, 5G, etc., or based on various standards or protocols, including General Packet Radio Service (GPRS), Enhanced Data rates for GSM Evolution (EDGE), Global System for Mobiles (GSM), Code Division Multiple Access (CDMA), Time Division Multiple Access (TDMA), Long-Term Evolution (LTE), 802.16 standards, etc.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. A computer-readable storage device encoded with instructions that, when executed, cause one or more processors of a computing system to perform operations of object registration, the operations comprising:
generating a first feature pyramid with a first plurality of levels for a first object, and a second feature pyramid with a second plurality of levels for a second object;
determining a first deformation field based on features of a first level of the first plurality of levels and features of a first corresponding level of the second plurality of levels;
warping features of a second level of the first plurality of levels based on the first deformation field;
determining a second deformation field based on features of the warped features of the second level of the first plurality of levels and features of a second corresponding level of the second plurality of levels; and
registering the first object to the second object based on the second deformation field.

2. The computer-readable storage device of claim 1, wherein the operations further comprise:
warping features of a third level of the first plurality of levels based on the second deformation field; and
determining a third deformation field based on the warped features of the third level of the first plurality of levels and features of a third corresponding level of the second plurality of levels.

3. The computer-readable storage device of claim 2, wherein the operations further comprise:
warping features of a fourth level of the first plurality of levels based on the third deformation field; and
determining a fourth deformation field based on the warped features of the fourth level of the first plurality of levels and features of a fourth corresponding level of the second plurality of levels; and
registering the first object to the second object based on the fourth deformation field.

4. The computer-readable storage device of claim 3, wherein the fourth deformation field is configured to include at least partial information of the first deformation field, the second deformation field, and the third deformation field.

5. The computer-readable storage device of claim 1, wherein the second deformation field has a higher resolution compared to the first deformation field.

6. The computer-readable storage device of claim 1, wherein the first level has a lower resolution compared to the second level.

7. The computer-readable storage device of claim 1, wherein the second object has a marked location with a label, wherein the operations further comprise:
marking a corresponding location on the registered first object based on the marked location on the second object.

8. The computer-readable storage device of claim 1, wherein the second object has a marked location with a label, wherein the operations further comprise:
labeling a corresponding location on the registered first object based on the label on the second object.

9. The computer-readable storage device of claim 1, wherein the registered first object has a first visual feature, and the second object has a second visual feature, the method further comprising:
generating a third object with the first visual feature and the second visual feature, wherein the first visual feature is placed on the third object based on a first location in respect to an orientation of the registered first object, and the second visual feature is placed on the third object based on a second location in respect to an orientation of the second object.

10. A computer-implemented method for object registration, comprising:
estimating a plurality of sequential deformation fields based on respective level-wise convolutional feature maps from corresponding levels of two feature pyramids associated with two objects;
sequentially warping, based on the plurality of sequential deformation fields, level-wise convolutional feature maps of one of the two feature pyramids; and
generating a final deformation field based on a last set of the warped level-wise convolutional features.

11. The method of claim 10, further comprising:
generating the two feature pyramids from the two objects; each of the two feature pyramids having a sequential levels in different resolutions.

12. The method of claim 10, further comprising:
up-sampling a deformation field of the plurality of sequential deformation fields to match a resolution of a next level of the one of the two feature pyramids.

13. The method of claim 10, wherein the estimating the plurality of sequential deformation fields comprises:
refining the plurality of sequential deformation fields to encode information of the two objects in a coarse-to-fine manner from high-level information to low-level information.

14. The method of claim 10, wherein the final deformation field comprises both high-level context information and low-level detailed information to register the two objects.

15. The method of claim 10, wherein the two objects are two brain images, the method further comprising:
geometrically aligning, based on the final deformation field, the two brain images; and
combining the two aligned brain images to generate a new brain image.

16. The method of claim 10, wherein the two objects are two three-dimensional volumes with different spatial scales, the method further comprising:
registering, based on the final deformation field, the two three-dimensional volumes with the different spatial scales.

17. A system for object registration, comprising:
a processor; and
a memory have instructions stored thereon, wherein the instructions, when executed by the processor, cause the processor to:
estimate a plurality of deformation fields based on respective features from corresponding levels of two feature pyramids associated with two objects;
warp, based on the plurality of deformation fields, features of respective levels of one of the two feature pyramids; and
generate a final deformation field based on warped features of a last level of the one of the two feature pyramids.

18. The system of claim 17, wherein the instructions, when executed by the processor, further cause the processor to refine the plurality of deformation fields to encode information of the two objects in a coarse-to-fine manner from high-level information to low-level information.

19. The system of claim 17, wherein the instructions, when executed by the processor, further cause the processor to geometrically align, based on the final deformation field, the two objects.

20. The system of claim 19, wherein the instructions, when executed by the processor, further cause the processor to identify a difference between the two aligned objects.
